(19) United States
(12) Patent Application Publication
(10) Pub. No.: US 2005/0217110 A1
(43) Pub. Date: Oct. 6, 2005

(54) Deposition repair of hollow items

(76) Inventor: Valeriy I. Topal, Kiev (UA)

Correspondence Address: BACHMAN & LAPOINTE, P.C., 900 CHAPEL STREET, SUITE 1201, NEW HAVEN, CT, 06510, US

(21) Appl. No.: 10/818,962

(22) Filed: Apr. 6, 2004

(51) Int. Cl. B26F 3/00; B26F 3/02

(52) U.S. Cl. 29/889.1; 29/402.09

(57) ABSTRACT

A component has an internal space and has lost first material from a damage site. At least a first portion of a sacrificial element is placed within the internal space. A repair material is deposited at least partially in place of the first material. The sacrificial element is removed.

### CROSS-REFERENCE TO RELATED APPLICATIONS

Copending U.S. Patent applications Ser. No. 10/377,954, filed Mar. 3, 2003, and entitled “Fan and Compressor Blade Dovetail Restoration Process”, Ser. No. 10/635,694, filed Aug. 5, 2003, and entitled “Turbine Element Repair”, Ser. No. 10/734,696, filed Dec. 12, 2003, and entitled “Turbine Element Repair”, and Ser. No. 10/804,754 filed Mar. 19, 2004 and entitled “Multi-Component Deposition” disclose apparatus and methods to which the present invention may be applied. applications Ser. Nos. 10/377,954, 10/635,694, 10/734,696, and 10/804,754 are incorporated herein in their entireties by reference as if set forth at length. Benefit of these applications under 35 USC 120 is not claimed.

### BACKGROUND OF THE INVENTION

1. Field of the Invention

The invention relates to the restoration of turbo machine parts. More particularly, the invention relates to the restoration of worn or damaged gas turbine engine fan, compressor and turbine blades and vanes made of nickel-, cobalt-, iron-, or titanium-based superalloy.

2. Description of the Related Art

The components of gas turbine engines are subject to wear and damage. Even moderate wear and damage of certain components may interfere with optimal operation of the engine. Particular areas of concern involve the airfoils of various blades and vanes. Wear and damage may interfere with their aerodynamic efficiency, produce dynamic force imbalances, and even structurally compromise the worn/damaged parts in more extreme cases. A limited reconditioning is commonly practiced for slightly worn or damaged airfoils wherein additional material is removed below the wear/damage to provide the airfoil with a relatively efficient and clean sectional profile albeit smaller than the original or prior profile. Exemplary inspection criteria establishing the limits to which such reconditioning can be made are shown in Pratt & Whitely AT8D Engine Manual (P/N 773128), ATA 72-33-21, Inspection—01, United Technologies Corp., East Hartford Conn. Such limits may differ among airfoils depending upon the location and particular application. The limits are typically based on structural and performance considerations which limit the amount of material that may be removed.

Various techniques have been proposed for more extensive restoration of worn or damaged parts of gas turbine engines. U.S. Pat. No. 4,822,248 discloses use of a plasma torch to deposit nickel- or cobalt-based superalloy material. U.S. Pat. No. 5,732,467 identifies the use of high velocity oxy-fuel (HVOF) and low pressure plasma spray (LPPS) techniques for repairing cracks in such turbine elements. U.S. Pat. No. 5,783,318 also identifies LPPS techniques in addition to laser welding and plasma transferred arc welding. U.S. Pat. No. 6,049,978 identifies further use of HVOF techniques. Such techniques have offered a limited ability to build up replacement material to restore an original or near original cross-section. However, the structural properties of the replacement material may be substantially limited relative to those of the base material.

Especially for larger damage, it is known to use preformed inserts which may be welded in place to repair damage. With such inserts, the damaged area is cut away to the predetermined shape of the insert which is, in turn, welded in place. Most advanced turbine alloys are difficult to weld by conventional means. Conventional welding results in cracks. There have been developments of specialized techniques using elevated temperature or special materials to address such cracking. U.S. Pat. No. 5,106,010 identifies one temperature-controlled welding process. Brazing may alternatively be used, but brazing may greatly reduce the temperature capability of the component. Neither brazing nor welding works well for regions of components that see both relatively high temperature and stress.

Accordingly, there remains room for improvement in the art.

### SUMMARY OF THE INVENTION

Accordingly, one aspect of the invention involves a method for restoring a component having an internal space and which has lost first material from a damage site. At least a first portion of a sacrificial element is placed within the internal space. A repair material is deposited at least partially in place of the first material. The sacrificial element is removed.

In various implementations, the damage site may extend into the internal space. The sacrificial element may have a first surface portion having a shape effective to re-form an internal surface portion of the component bounding the internal space. The placing may cause the first surface portion to at least partially protrude from an intact portion of the component. The depositing of the repair material may include depositing the repair material atop the first surface portion. Additional material may be removed at least partially from the damage site to create a base surface. The depositing may deposit the repair material atop the base surface at least partially in place of the first material and the additional material. The deposited repair material may, in major part, replace the first material. The component may be an internally-cooled gas turbine engine turbine section element. The repair material may be selected from the group consisting of Ni—, Co—, Fe—, or Ti-based superalloy. The component may be a blade having an airfoil and the damage site may be along a leading edge of the airfoil or a tip of the airfoil. The first material may be lost to a depth of at least 2.0 mm. The depositing may involve at least one of: plasma spray deposition; high velocity oxy-fuel deposition; low pressure plasma spray deposition; and electron beam physical vapor deposition. Deposited repair material may be machined to restore an external contour of the airfoil. The placing may involve forming in situ or trimming a pre-formed insert. The removing may involve at least one of chemically removing and thermally removing.

Another aspect of the invention involves a sacrificial insert for restoring a turbine airfoil element. A first surface portion registers the insert with an intact internal surface of the turbine airfoil element. A second surface portion has a shape effective to re-form an internal surface portion of the element bounding an internal space.

In various implementations, the insert may consist essentially of one or more salts or of one or more ceramics. The insert may consist in major part of one or more salts selected from the group consisting of chlorides and fluorides. The insert may consist in major part of alumina. The first and second surface portions may include associated portions of pressure and suction side faces of the insert and may define surface enhancements to be replaced/restored.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of a turbine blade of a gas turbine engine.

FIG. 2 is a chordwise sectional view of the airfoil of the blade of FIG. 1.

FIG. 3 is a median sectional view of a tip portion of the airfoil of the blade of FIG. 1.

FIG. 4 is a sectional view of the airfoil of FIG. 2 upon damage.

FIG. 5 is a sectional view of the airfoil of FIG. 3 during repair.

FIG. 6 is a sectional view of the airfoil of FIG. 5 after repair.

FIG. 7 is a sectional view of the airfoil of FIG. 3 upon damage.

FIG. 8 is a sectional view of the airfoil of FIG. 7 in an intermediate stage of repair.

FIG. 9 is a sectional view of the airfoil of FIG. 8 in a subsequent stage of repair.

FIG. 10 is a sectional view of the airfoil of FIG. 9 after repair.

Like reference numbers and designations in the various drawings indicate like elements.

### DETAILED DESCRIPTION

FIG. 1 shows a turbine element (e.g., a gas turbine engine turbine section blade 22). The exemplary blade 22 includes an airfoil 24 extending from a root 26 at a platform 28 to a tip 30. The airfoil has leading and trailing edges 32 and 34 separating pressure and suction sides 36 and 38. The platform has an outboard portion 40 for forming an inboard boundary/wall of a core flowpath through the turbine engine. A mounting portion or blade root 42 depends centrally from the underside of the platform 40 for fixing the blade in a disk of the turbine engine. Optionally, all or some portion (e.g., the platform 40 and airfoil 24) may be coated. A cooling passageway network (not shown in FIG. 1) may extend through the blade from one or more inlets in the root to multiple outlets along the blade sides, edges, tip, and/or root. Exemplary blades may be made from nickel- or cobalt-based superalloy.

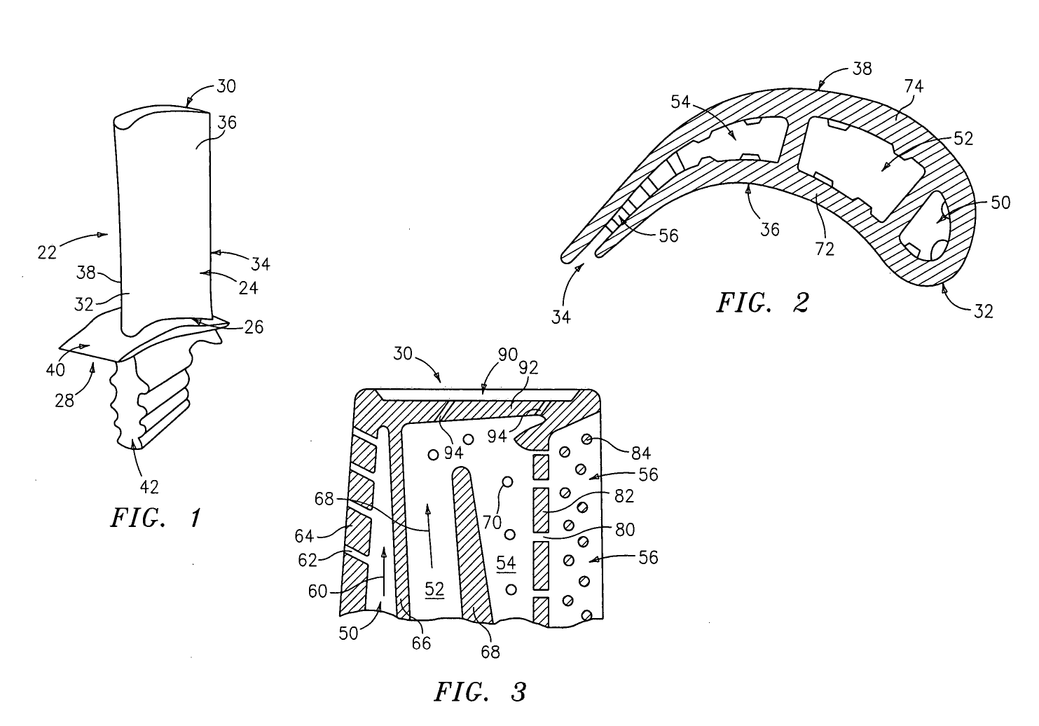

FIG. 2 shows portions of the cooling passageway network. The illustrated blade and network are illustrative. Those skilled in the art will recognize that other component envelope and passageway configurations are possible. The network includes a leading passageway or cavity 50, a second cavity 52 aft thereof, a third cavity 54 aft thereof, and a fourth cavity or trailing edge slot 56 yet further aft. FIG. 3 shows an implementation wherein the leading cavity 50 directs a cooling flow 60 from inboard to outboard and incrementally exiting through a spanwise series of leading edge cooling outlet passageways 62 in a leading edge wall portion 64. The second cavity 52 is separated from the leading cavity 50 by a wall portion 66. The exemplary second and third cavities are legs of a single passageway separated by a wall portion 68, with the second cavity 52 carrying a flow 68 in an outboard direction and the third cavity 54 returning the flow in an inboard direction. The second and third cavities may contain pedestal stubs 70 or other surface enhancements extending from pressure and suction side surfaces of respective pressure and suction side wall portions 72 and 74 (FIG. 2). Alternatively or additionally, pedestals (not shown) may extend between the sides. The inboard flow through the third cavity 54 incrementally exits aft through apertures 80 in a wall 82 dividing the third cavity from the slot 56. The slot 56 extends to the trailing edge and has a number of pedestals 84 extending between pressure and suction side surfaces of the respective pressure and suction side wall portions. In the exemplary embodiment, the tip 30 has a tip cavity or pocket 90 separated from the internal cavities by a wall 92 and having outlet passageways 94 therein for venting air from the flow 68.

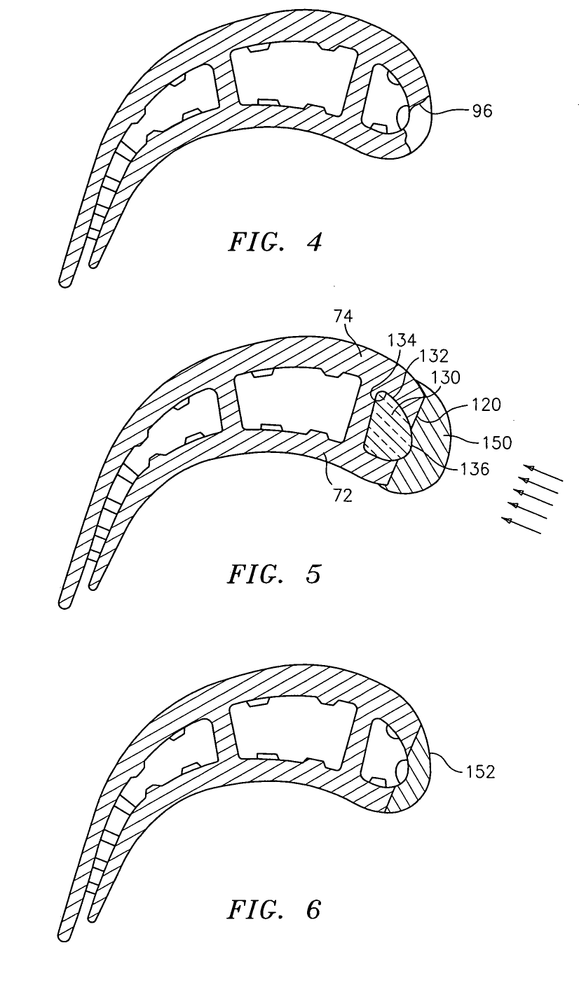

FIG. 4 shows localized damage such as is associated with foreign object damage (FOD) nicking or chipping the airfoil proximate the leading edge to create a damaged leading portion penetrating to and exposing the leading cavity 50. The exemplary damaged surface 96 includes portions along leading portions of the walls 72 and 74. In addition or alternative to FOD, the airfoil may be subject to more general damage such as wear or erosion. Even when the damage itself does not penetrate the leading cavity, the penetration may be close enough to the leading cavity that repair attempts may penetrate the cavity. For example, it may be desired to true damage surfaces prior to repair as is described in application Ser. No. 10/635,694. Such truing may penetrate the cavity.

According to the invention, repair material may be deposited in association with a cavity or other part internal space. The damage site is advantageously cleaned of contamination. Protective coatings may be locally or globally removed. Further removal of base material may provide an advantageous base surface for receiving deposition. In the exemplary restoration procedure, after the damage/wear, the remaining base material of the blade is ground to a preset configuration such as providing an angled leading facet or base surface 120 (FIG. 5). The exemplary base surface 120 has portions on opposite sides of an exposed opening to the leading cavity (e.g., portions along the pressure and suction side wall portions 72 and 74). A sacrificial element 130 is placed within the leading cavity. An exemplary sacrificial element is formed in situ by injecting a flowable material into the cavity and permitting the material to harden. Exemplary material is an aqueous paste (e.g., a salt-based filler compound) which dries in place. Advantageous composition of the filler compounds and advantageous filling techniques, as well as subsequent removal techniques (described below), may depend upon the part material and the cavity shape and dimensions. In some cases filler material may be applied by spraying (e.g., gas plasma, plasma, etc.). In other cases, for instance when narrow and deep hollow passageways are filled, a slip casting process may be used. A slip is a liquid suspension and/or solution containing particulate matter. The opening at the damage site may be plugged or covered (e.g., via a tape mask) to locally close the cavity. The liquid may then be introduced to the cavity (e.g., via pouring through the root of a blade). As the liquid evaporates, the particulate is left behind forming a crust on the surface of the cavity. Additives may give the crust enhanced structural integrity if the flocculated particles don't have sufficient structural integrity themselves. This crust can be baked at a low temperature to obtain the structural integrity if needed. The plug/cap/mask may be removed.

Chlorides and fluorides or their mixtures may be used that sublimate upon heating above a sublimation temperature under vacuum. This permits their removal (described below) via sublimation. Salts and other compounds soluble in water, acids, or sodium solutions could be used for removal via dissolving and/or chemical reaction. In exemplary repair of Ni-based superalloy components having narrow cavities, sublimable materials may be advantageous due to. limited exposed surface area for dissolving. Sodium fluoride will start to sublimate in the vicinity of 850 C; magnesium fluoride at 980 C; and a double salt of sodium fluoride and magnesium fluoride at 900 C. For Ti-based superalloy lithium fluoride may advantageously be used due to a lower sublimation temperature in the vicinity of 750 C. For Co-based superalloy sodium chloride may advantageously be used due to either its ease of dissolving in water or its much lower sublimation temperature in the vicinity of 700 C.

In the exemplary embodiment, the element 130 has an exterior surface with a portion 132 contacting an intact portion of a cavity-defining surface 134 and a portion 136 exposed. The portion 136 advantageously complements the lost portion of the cavity-defining surface and may protrude beyond an opening in the damaged cavity. For example, the protrusion may be sculpted to have the desired shape. Optionally, the sacrificial element may be formed prior to the machining of the base surface or other treatment.

With the element 130 in place, repair material 150 is deposited atop the base surface 120 and element surface portion 136 to gradually build up to at least partially replace the lost material and, preferably, more than replace it. Deposition may be as described in applications Ser. Nos. 10/635,694, 10/734,696, 10/377,954, and 10/804,754 or otherwise. After deposition, the deposited material may be trimmed back to an external surface contour 152 corresponding to the contour of the lost material (FIG. 6) such as via machining and the element 130 may be destructively removed such as by chemical processes (e.g., dissolving, reacting, and the like) and/or thermal processes (e.g., melting, vaporizing, thermal decomposition, and the like). There may further be a restoration of coating to the affected area or to the blade overall. Additional variations may be as described in application Ser. No. 10/635,694 or otherwise.

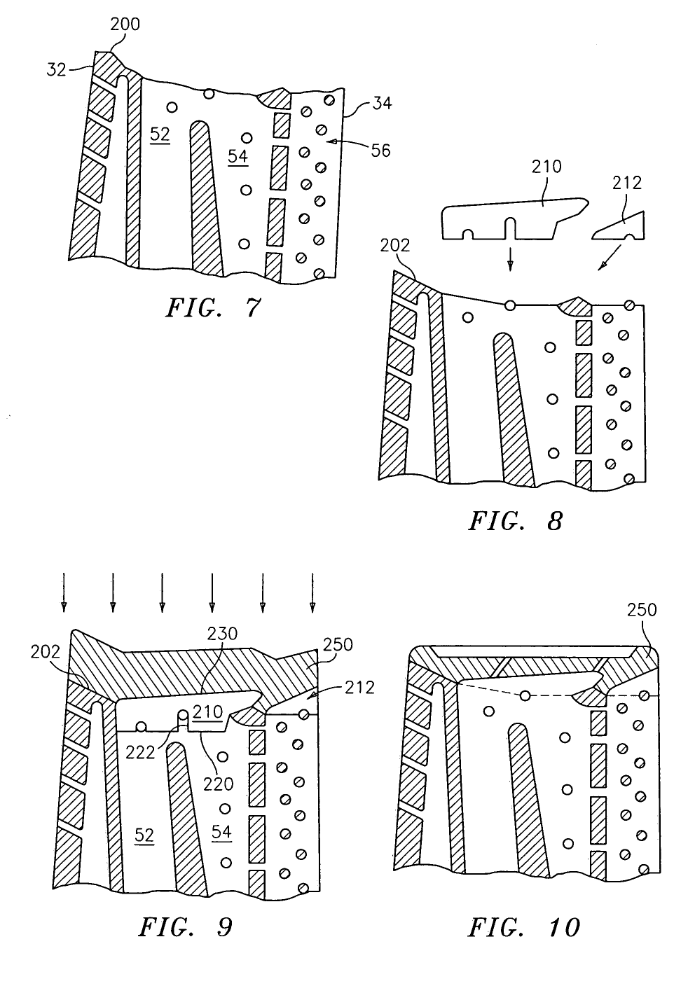

FIG. 7 shows damage to the tip area of the blade of FIG. 3. In the exemplary damage, a tip portion has been removed completely between the leading and trailing edges 32 and 34 penetrating to the cavities 52, and 54 and the slot 56, although other damage is possible. A damaged surface is shown as 200. Material may be removed from below the surface 200 to create one or more facets 202 (FIG. 8) or other prepared surfaces for receiving deposition material. In lieu of or in addition to use of in situ formed sacrificial elements, FIG. 8 shows pre-formed insert elements 210 and 212 which may be inserted (e.g., partially into the opening(s) to the cavities created at the damage site by the damage and/or by subsequent machining). Exemplary inserts are molded from the aforementioned salts (e.g., chlorides, fluorides or their mixtures) or other materials heretofore or subsequently used for to manufacture investment casting cores and shells (e.g., Al₂O₃). The inserts may be made using existing or subsequent core-manufacturing technology (e.g., molding and firing of ceramic materials).

FIG. 9 shows the inserts 210 and 212 in place. The exemplary insert 210 is a main insert for restoring the inboard surface of the end wall 92 along the cavities 52 and 54. The exemplary insert 212 is a trailing slot insert for restoring the inboard surface of the end wall along the slot 56. When associated with flat cavities having generally parallel sides, the inserts may be flat having corresponding side surfaces, a portion of each of which may engage an intact portion of the associated cavity-defining surface and a remaining portion of which protrudes. The side surfaces may have blind or through apertures corresponding to surface area enhancements (e.g., pedestals, posts, trip strips, wall portions and the like to be replaced or restored) Transverse to these side surfaces, the exemplary first insert 210 has a perimeter surface portion 220 dimensioned to be positioned within the associated cavities 52 and 54. For precisely registering the insert, the perimeter portion 220 may itself have portions such as 222 defining blind slots for engaging associated intact pedestals or other intact structure. The perimeter may have a second portion 230 along the protruding portion of the insert for reforming the inboard surface of the wall 92 of FIG. 3. The second insert may be similarly formed. The inserts may be preformed in their final conditions in which case it may be appropriate to machine the damaged area down to a single predetermined configuration regardless of the extent of the damage as long as such damage is within a wide range appropriate for repair with such insert. Alternatively, however, inserts may initially be maximally sized or otherwise oversized. For example, an insert could be up to a near positive of an entire passageway network or portion thereof. With relatively minimal machining or other preparation of the damage site a portion of the insert may be cut off for installation. This portion may correspond to the portion necessary to protrude from the damaged area and a small portion sufficient to extend into the undamaged area and register the insert. The remainder of the insert could be discarded or even used for other repairs of other areas of the same or a similar airfoil.

FIG. 9 further shows repair material 250 deposited atop the base surface defined by the facets 202 and the surfaces of the inserts protruding from the airfoil. After deposition, as with the leading edge repair, the tip area may be machined to restore the final surface contour of the airfoil , including milling of the tip pocket and drilling of the passageways 94. The insert may be and additional processing (if any) performed.

One or more embodiments of the present invention have been described. Nevertheless, it will be understood that various modifications may be made without departing from the spirit and scope of the invention. For example, although particularly useful with fan blades, the methods may be applied to other blades and other turbine engine parts and non-turbine parts. Details of the particular turbine engine part or other piece and the particular wear or damage suffered may influence details of any given restoration. Accordingly, other embodiments are within the scope of the following claims.

1. A method for restoring a component having an internal space and which has lost first material from a damage site comprising:
placing at least a first portion of a sacrificial element within the internal space;
depositing a repair material at least partially in place of the first material; and
removing the sacrificial element.

2. The method of claim 1 wherein:
the damage site extends to the internal space.

3. The method of claim 1 wherein:
the sacrificial element has a first surface portion having a shape effective to re-form an internal surface portion of the component bounding the internal space;
the placing causes the first surface portion to at least partially protrude from an intact portion of the component; and
the depositing the repair material includes depositing said repair material atop the first surface portion.

4. The method of claim 1 wherein:
the sacrificial element first surface portion defines at least one internal feature selected from the group consisting of pedestals, posts, and trip strips.

5. The method of claim 1 wherein:
the method further comprises removing additional material at least partially from the damage site to create a base surface; and
the depositing deposits said repair material atop the base surface at least partially in place of the first material and the additional material.

6. The method of claim 1 wherein:
said deposited repair material in major part replaces said first material.

7. The method of claim 1 wherein:
the component is an internally-cooled gas turbine engine turbine section element.

8. The method of claim 1 wherein said repair material is selected from the group consisting of Ni-, Co-, Fe-, or Ti-based superalloy.

9. The method of claim 1 wherein said component comprises a substrate material selected from the group consisting of Ni-, Co-, Fe-, or Ti-based superalloy.

10. The method of claim 1 wherein the component is a blade having an airfoil and the damage site is along a leading edge of the airfoil.

11. The method of claim 1 wherein the component is a blade having an airfoil and the damage site is along a tip of the airfoil.

12. The method of claim 1 wherein the component is a blade having an airfoil and the damage site is along a trailing edge of the airfoil.

13. The method of claim 1 wherein the component is a blade having a platform and an airfoil and the damage site is along the platform.

14. The method of claim 1 wherein the first material is lost to a depth of at least 2.0 mm.

15. The method of claim 1 wherein said depositing comprises at least one of: plasma spray deposition; high velocity oxy-fuel (HVOF) deposition; low pressure plasma spray (LPPS) deposition; and electron beam physical vapor deposition (EB PVD).

16. The method of claim 1 further comprising:
machining deposited repair material to restore an external contour of the airfoil.

17. The method of claim 1 wherein the placing comprises forming in situ.

18. The method of claim 1 wherein the placing comprises trimming a pre-formed insert.

19. The method of claim 1 wherein the removing comprises at least one of chemically removing and thermally removing.

20. A sacrificial insert for restoring a turbine airfoil element having an internal space comprising:
a first surface portion for registering the insert with an intact internal surface of the turbine airfoil element; and
a second surface portion having a shape effective to re-form an internal surface portion of the element bounding the internal space.

21. The insert of claim 20 consisting essentially of: one or more salts; or one or more ceramics.

22. The insert of claim 20 consisting in major part of one or more salts selected from the group consisting of chlorides and fluorides.

23. The insert of claim 20 consisting in major part of alumina.

24. The insert of claim 20 wherein:
the first and second surface portions include associated portions of pressure and suction side faces of the insert.

25. The insert of claim 20 wherein:
the first and second surface portions define one or more internal surface enhancements.
